(19) United States
(12) Patent Application Publication
(10) Pub. No.: US 2025/0315851 A1
(43) Pub. Date: Oct. 9, 2025

(54) SYSTEM AND METHOD FOR PREDICTING EVENT MARKET ODDS OUTCOMES USING CROWD-SOURCED SENTIMENT AND CUSTOM ODDS WITH ARTIFICIAL INTELLIGENCE

(71) Applicant: Neesan Labs LLC, Morton Grove, IL (US)

(72) Inventor: Ramsen Neesan, Morton Grove, IL (US)

(73) Assignee: Neesan Labs LLC, Morton Grove, IL (US)

(21) Appl. No.: 19/174,326

(22) Filed: Apr. 9, 2025

Related U.S. Application Data
(60) Provisional application No. 63/631,728, filed on Apr. 9, 2024.

(51) Int. Cl. G06Q 30/0202

(52) U.S. Cl. CPC G06Q 30/0202

(57) ABSTRACT

The present disclosure provides a system and method for capturing user sentiment and generating custom market odds across a wide range of event types, enhancing predictive accuracy using artificial intelligence. Unlike traditional systems that limit users to static, third-party odds, the present disclosure allows users to actively participate in the event forecasting process by expressing sentiment and optionally creating custom odds, including for proposition and parlay-style markets.

### CROSS-REFERENCE TO RELATED APPLICATION

This application claims the benefit of U.S. Provisional Patent Application No. 63/631,728 filed Apr. 9, 2024. The disclosure of the above application is incorporated herein by reference in its entirety.

### FIELD

The present disclosure relates generally to the field of mobile and desktop applications for event-based forecasting and prediction, and more particularly, to a system and method for predicting event market odds based on crowd-sourced user sentiment.

### BACKGROUND

Traditional prediction platforms and online wagering systems rely heavily on externally published odds from centralized sources such as sportsbooks, polling agencies, or market analysts. These systems typically offer users limited interactivity, allowing only passive engagement with pre-defined odds. In such systems, users are often unable to meaningfully disagree with published values or submit their own alternative market interpretations.

Furthermore, while existing systems may support event prediction at a basic outcome level (e.g., win/loss), they often lack support for more granular or complex market structures, such as: proposition-based markets, where predictions involve specific statistical thresholds or performance metrics (e.g., “Will a player score more than 2 goals?” or “Will a stock close above $100?”); parlay or multi-leg events, which require a combination of multiple outcome conditions to be met for a composite prediction to succeed. These limitations create a disconnect between real-time public sentiment and the published market valuations, reducing the overall utility of the platform for insight generation or forecasting accuracy. Accordingly, while such prediction platforms and online wagering systems do work well for their intended purpose, there exists an opportunity for improvement in the relevant art.

### SUMMARY

The present disclosure provides a novel system and method for capturing user sentiment and generating custom market odds related to user sentiment across a wide range of event types, with the goal of enhancing predictive accuracy using artificial intelligence (AI). As used herein, the term “sentiment” is used to generally refer to a users' opinion, or an average of a collection of users' opinions, regarding a predicted outcome (e.g., such as published odds from a centralized source) of a given event. Unlike traditional systems that limit users to static, third-party odds, this present disclosure allows users to actively participate in the event forecasting process by expressing sentiment and optionally creating custom odds, including for proposition, parlay-style and prediction-style markets.

The present disclosure addresses the shortcomings identified above by introducing a dynamic, user-driven platform that provides improvements including, but not limited to: (1) Enabling expression of sentiment toward event outcomes in a flexible, implementation-neutral manner (e.g., “agree/disagree,” “like/dislike,” etc.); (2) Allowing for the creation and submission of custom market odds, including both single-outcome and multi-leg (parlay-style) predictions; (3) Supporting proposition-based prediction markets involving specific participant metrics or in-event conditions; and (4) Utilizing a robust AI engine trained on historical and real-time user input and event data to generate predictive insights.

By integrating these capabilities, the present disclosure establishes a new model of community-influenced event forecasting—one in which users contribute meaningfully to market valuations, and machine learning processes that derive predictive power from the collective intelligence of the crowd.

The field of the present disclosure primarily encompasses event analytics, computer science, AI, and interactive system design. The development and implementation of this event-based prediction platform requires expertise in data analysis and the application of statistical methods to evaluate market odds performance and participant sentiment data to predict event outcomes. Additionally, the present disclosure leverages principles of computer science, including algorithm design, machine learning, and AI, to facilitate real-time insight generation, predictive modeling, and personalized user recommendations.

Also, the interactive design aspect involves creating an engaging user experience that incorporates user interface (UI) and user experience (UX) design, social collaboration, and dynamic feedback within the platform. By integrating these fields of study, the present disclosure provides a data-driven and community-oriented solution for analyzing and forecasting outcomes across diverse types of events.

The system facilitates user interaction with externally sourced or system-generated market odds through a dynamic interface that supports expressions of agreement or disagreement—represented through customizable mechanisms such as “like/dislike,” “agree/disagree,” or equivalent. These expressions, combined with optional custom odds input, are collected and processed in real time.

Users may interact with single-outcome markets, proposition-based markets (e.g., whether a specific participant exceeds a performance metric), and parlay-style or multi-leg events that involve a combination of conditional outcomes. The present disclosure supports configurable odds types including binary, range-based, or multi-outcome formats, and enables users to input their own modified probability values for any of the above.

The system architecture includes the following core functional components:

Data Collection—Published event market odds and user input (sentiment and custom odds) are ingested from multiple sources and interfaces.

Outcome Recording and Data Structuring—Event results are stored and correlated with prior user sentiment and odds input.

Data Normalization—Collected data is converted into consistent formats to support cross-event comparison and training.

Artificial Intelligence Model Training—One or more machine learning models are trained on historical and contemporary user input and event outcomes.

Prediction Generation—The AI engine generates real-time and future-facing predictions, confidence metrics, and sentiment trend insights.

This method transforms static event markets into a dynamic, user-influenced forecasting environment, enabling higher-quality prediction and deeper engagement. The present disclosure is broadly applicable to sports, politics, finance, entertainment, and any other outcome-based domain where user sentiment and alternative market hypotheses can inform predictive analytics.

Exemplary use cases include, but are not limited to: (1) Sports events, (2) Political elections; (3) Financial markets; and (4) Prediction markets.

In one example related to sports markets, a user agrees on the underdog team on the moneyline, while others disagree and propose alternate spreads. The AI evaluates collective input to predict a higher-than-expected probability for an upset.

In one example related to political elections, a user's express sentiment on a candidate's win probability. Custom odds differ significantly from published polls. The AI correlates this deviation with historically accurate predictors.

In one example related to financial markets, users predict price movement for a stock by setting up event-based odds (e.g., “Will XYZ close above $100 this week?”). Sentiment trends influence the AI forecast.

In one example related to prediction markets, users buy and sell “shares” in the outcome of a future event. The current price of a share reflects the crowd's collective belief in the likelihood of that outcome. These are often referred to as information markets, because the market price aggregates diverse opinions and information.

The present disclosure provides many advantages over existing systems such as, but not limited to: (1) User influence; (2) Sentiment integration; (3) AI-Driven accuracy; (4) Event flexibility; (5) Al Training and Inference; and (6) Display to users.

Regarding user influence, unlike static odds systems, users of the system of the present disclosure can shape market interpretations by generating alternative odds.

Regarding sentiment integration, the system of the present disclosure captures crowd psychology as a predictive signal, which traditional external data sources or current online wagering platforms do not utilize.

With regard to AI-driven accuracy, the system of the present disclosure utilizes real-world user sentiment and interaction patterns as input into AI models that evolve over time.

With regard to event flexibility, the system of the present disclosure is not limited to sports, making it applicable to any event with measurable outcomes and public interest.

Regarding AI training and inference, the system of the present disclosure uses supervised learning models that are trained on historical and contemporary sentiment data and event outcomes. Features may include: Distribution of user sentiment (percent agree vs. disagree); Average deviation of custom odds from published odds; Accuracy scores from previous predictions; Time-based shifts in sentiment; The trained model will output but not limited to: A predicted probability distribution for upcoming event outcomes, Confidence scores based on historical sentiment performance, Trend indicators across similar events or users.

Regarding display to users, with the system of the present disclosure, the resulting predictions are displayed to users as dynamic insights. This may include: AI-enhanced probabilities alongside published odds; Visualizations of community sentiment and forecast accuracy; Recommendations or alerts about outlier sentiment activity.

A computer implemented method and computing system for predicting an outcome from an event based on user sentiment is provided. The method includes: receiving, at a computing device having one or more processors, event market data, the event market data having a first predicted outcome from the event; displaying, as rendered graphics on a visual display of the computing device, the first predicted outcome; displaying, as rendered graphics on the visual display, available prompt selections indicative of a like and a dislike, wherein the like represents agreement with the first predicted outcome and the dislike represents disagreement with the first predicted outcome; receiving, at the computing device, feedback associated with the first predicted outcome based on one of a selected like and dislike; assigning and storing, at the computing device, a user sentiment score related to the user feedback; and displaying, as rendered graphics on the visual display, the user sentiment score concurrently with the first predicted outcome from the event market data. The user sentiment score can be associated with one user or an aggregated score (such as average, minimum and maximum) from a plurality of users. A user sentiment score can be weighted such that a user's sentiment from a user that has historically accurate predictions counts more toward an average sentiment in an aggregated score.

In other features, the method further includes: displaying, as rendered graphics on the visual display, and resulting from a selected dislike user feedback, available prompt selections indicative of customizing the first predicted outcome; and displaying, as rendered graphics on the visual display, a field that receives a user new customized value that contradicts the first predicted outcome.

In other implementations, the assigning and storing, at the computing device further includes: assigning the user new customized value as user defined odds to the user sentiment score and wherein the user sentiment score includes the user defined odds.

In additional features, the method includes: displaying, as rendered graphics on the visual display, a timeline or trend graph showing sentiment fluctuations over time for the first predicted outcome.

In other features, the method further includes: displaying, as rendered graphics on the visual display, and resulting from the user defined odds, an available prompt indicative (i) of a reason for the user new customized value; and (ii) a confidence score of the customized value indicative of a user's level of confidence related to the customized value.

In other features, the method further includes: receiving, at the computing device, feedback associated with the first predicted outcome from multiple users; aggregating the feedback associated with the first predicted outcome from the multiple users; and wherein the user sentiment score is displayed as rendered graphics on the visual display in real-time and is indicative of the aggregated feedback from the multiple users.

In additional features, the method further includes: displaying, as rendered graphics on the visual display, at least one of an average, a minimum and a maximum customized value related to the feedback associated with the first predicted outcome from the multiple users.

In other features, the method includes: collecting, at an artificial intelligence module of the computing device, (i) historical event results; and (ii) historical sentiment data; collecting, at the AI module of the computing device, contemporary event data; contemporary user sentiment data from the user sentiment score; predicting a result of the event on a trained model executed at the AI module based on the historical event results, historical user sentiment data, contemporary event results and the contemporary user sentiment data; and displaying, as rendered graphics on the visual display, AI predictions based on the predicated result.

In additional implementations, the method includes: determining, at the computing device, a result from the event upon conclusion of the event; comparing the result to the user defined odds; assigning a user ranking based on the comparing; and displaying, as rendered graphics on a visual display, the user ranking.

In other features, the user sentiment score and user new customized value is weighted based on the user ranking.

In additional features, the event comprises one of a sporting competition, political race, entertainment award, and financial forecast.

In other examples, the outcome comprises one of a winner of the event, a statistic related to the event, a combined multiple event outcome.

### BRIEF DESCRIPTION OF THE DRAWINGS

The accompanying drawings, which are included to provide a better understanding of the disclosure, illustrate embodiment(s) of the disclosure and, together with the description, serve to explain the principle of the disclosure. In the drawings:

FIG. 1 is a diagram of an example computing system including an example computing device that implements an outcome prediction platform according to the principles of the present disclosure;

FIGS. 2A, 2B and 2C show exemplary steps executed by the user sentiment data collection module of the outcome prediction platform according to the principles of the present disclosure;

FIG. 3 shows exemplary steps executed by the event data collection module of the outcome prediction platform according to the principles of the present disclosure;

FIG. 4 shows exemplary steps executed by the data storage and processing module of the outcome prediction platform according to the principles of the present disclosure;

FIGS. 5A, 5B and 5C show exemplary steps executed by the Al module of the outcome prediction platform according to the principles of the present disclosure;

FIG. 6 shows exemplary steps executed by the outcome predictions module of the outcome prediction platform according to the principles of the present disclosure;

FIG. 7A is an exemplary graphical user interface of the computing

device of FIG. 1 shown displaying pre-start event market odds details with user sentiment visual elements not submitted;

FIG. 7B is an exemplary graphical user interface of the computing device of FIG. 1 shown displaying pre-start event details for the proposition market odds with user sentiment visual elements not submitted;

FIG. 7C is an exemplary graphical user interface of the computing device of FIG. 1 shown displaying pre-start event details for multiple concurrent event selections, or parlays, market odds with user sentiment visual elements not submitted;

FIG. 8A is an exemplary graphical user interface of the computing device of FIG. 1 shown with a user disagreeing with current market odds point value and entering an alternate new value, in the example shown from “−11.5” to “−7.5”.

FIG. 8B is an exemplary graphical user interface of the computing device of FIG. 1 shown with a user agreeing to add a reason for their market odds point customization value with a disagreeable or dislike submitted sentiment.

FIG. 8C is an exemplary graphical user interface of the computing device of FIG. 1 shown with a user agreeing to add a confidence score for their market odds point customization value with a disagreeable or dislike submitted sentiment.

FIG. 9A is an exemplary graphical user interface of the computing device of FIG. 1 shown with post-start event details for the proposition market odds with total user sentiment visual elements submitted.

FIG. 9B is an exemplary graphical user interface of the computing device of FIG. 1 shown with post-start event details for the proposition market odds with user sentiment visual elements submitted for a given user;

FIG. 9C is an exemplary graphical user interface of the computing device of FIG. 1 shown displaying post-start event details for multiple concurrent event selections, or parlays, market odds with user sentiment visual elements submitted for a given user;

FIG. 9D is an exemplary graphical user interface of the computing device of FIG. 1 shown displaying the post-start event market odds details with total user sentiment visual elements submitted;

FIG. 9E is an exemplary graphical user interface of the computing device of FIG. 1 shown displaying post-start event details for the proposition market odds with total user sentiment visual elements submitted;

FIG. 9F is an exemplary graphical user interface of the computing device of FIG. 1 shown displaying post-start event details for the parlay market odds with total user sentiment visual elements submitted;

FIG. 9G is an exemplary graphical user interface of the computing device of FIG. 1 shown displaying the post-start event market odds customized spread, total over, and total under point details including the average, minimum, and maximum values for each event participant values.

FIG. 10A is an exemplary graphical user interface of the computing device of FIG. 1 shown displaying the AI predictions of the optimal moneyline price market odds values, which participant the AI predicts will win the match, and is the published moneyline market odds appropriate predictions based on the AI model training and execution of the total collected historical and contemporary user sentiment and event data for a pre-start event;

FIG. 10B is an exemplary graphical user interface of the computing device of FIG. 1 shown displaying the AI predictions of the optimal spread point market odds values and the optimal spread outcome prediction based on the AI model training and execution of the total collected historical and contemporary user sentiment and event data for a pre-start event;

FIG. 10C is an exemplary graphical user interface of the computing device of FIG. 1 shown displaying the AI predictions of the optimal total point market odds values and the optimal total outcome prediction based on the AI model training and execution of the total collected historical and contemporary user sentiment and event data for a pre-start event;

FIG. 10D is an exemplary graphical user interface of the computing device of FIG. 1 shown displaying the AI predictions of which event participant is favorite to win and is the event spread point market odds value appropriate based on the AI model training and execution of the total collected historical and contemporary user sentiment and event data for a pre-start event;

FIG. 10E is an exemplary graphical user interface of the computing device of FIG. 1 shown displaying the AI prediction of whether the total point market odds will be over or under based on the AI model training and execution of the total collected historical and contemporary user sentiment and event data for a pre-start event;

FIG. 10F is an exemplary graphical user interface of the computing device of FIG. 1 shown displaying the AI predictions for pre-start event market odds details with total user sentiment visual elements submitted.

FIG. 10G is an exemplary graphical user interface of the computing device of FIG. 1 shown displaying the AI predicted pre-start event details for the proposition market odds with total user sentiment visual elements submitted;

FIG. 10H is an exemplary graphical user interface of the computing device of FIG. 1 shown displaying the AI predicted pre-start event details for the parlay market odds with total user sentiment visual elements submitted;

FIG. 11 is an exemplary graphical user interface of the computing device of FIG. 1 shown displaying exemplary statistics for the user according to various examples of the present disclosure;

FIG. 12A is an exemplary graphical user interface of the computing device of FIG. 1 shown displaying pre-start event market odds details with user sentiment visual elements not submitted by market odds type;

FIG. 12B is an exemplary graphical user interface of the computing device of FIG. 1 shown displaying pre-start proposition market odds details with user sentiment visual elements not submitted by market odds type;

FIG. 12C is an exemplary graphical user interface of the computing device of FIG. 1 shown displaying pre-start event details for multiple concurrent event selections, or parlays, market odds with user sentiment visual elements not submitted by market odds type;

FIG. 12D is an exemplary graphical user interface of the computing device of FIG. 1 shown displaying the user sentiment agreeable submission;

FIG. 12E is an exemplary graphical user interface of the computing device of FIG. 1 shown displaying the user sentiment disagreeable submission;

FIG. 13A is an exemplary graphical user interface of the computing device of FIG. 1 shown displaying post-start event market odds details with user sentiment visual elements submitted by market odds type;

FIG. 13B is an exemplary graphical user interface of the computing device of FIG. 1 shown displaying post-start proposition market odds details with user sentiment visual elements submitted by market odds type;

FIG. 13C is an exemplary graphical user interface of the computing device of FIG. 1 shown displaying post-start event details for multiple concurrent event selections, or parlays, market odds with user sentiment visual elements submitted by market odds type; and

FIG. 14 is an exemplary graphical user interface of the computing device of FIG. 1 shown displaying an exemplary plot of sentiment trend over time according to various examples of the present disclosure.

### DETAILED DESCRIPTION

The present disclosure provides systems and methods for predicting outcomes of events. In examples, the system enables users to express sentiment and generate custom market odds for single and multi-outcome events, including proposition-based and parlay-style scenarios. These user inputs are collected, normalized, and processed using artificial intelligence to enhance the accuracy and responsiveness of event forecasting models. The system and techniques described herein provide an interactive, dynamic, and immersive user experience centered around participant sentiment and custom market creation for a wide range of events.

In some implementations, the system is a platform-agnostic system (operating on mobile and desktop devices) that allows users to express sentiment and create custom market odds for a variety of events. The system processes these interactions to improve the accuracy and relevance of event outcome predictions through the application of artificial intelligence.

In one objective of the system, user input (sentiment) on event outcome probabilities is collected. The user inputs from a plurality of users is used to inform and train predictive models. In doing so, the platform facilitates a dynamic feedback loop to the user between published market odds, user sentiment, and AI-based forecasting.

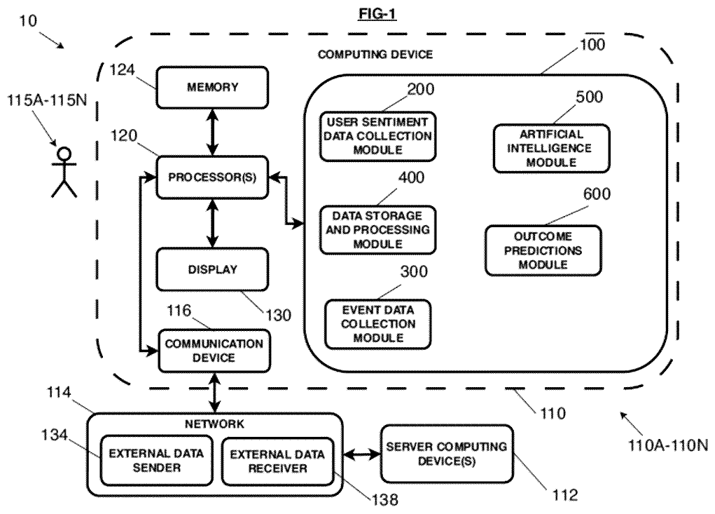

With initial reference to FIG. 1, a diagram of an example computing system 10 is illustrated. The computing system 10 can be configured to implement an outcome prediction platform 100 described herein, e.g., amongst a plurality of users via their computing devices. As will become appreciated herein, the outcome prediction platform 100 is used to assist in predicting outcomes of events based on user sentiment. The computing system 10 can include one or more example computing devices 110, represented as 110A-100N, and one or more example server computing devices 112 that communicate via a network 114 according to some implementations of the present disclosure.

For ease of description, in this application and as shown in FIG. 1, one example computing device 110 and one example server computing device 112 are illustrated and described. It should be appreciated, however, that there can be more computing devices 110 (e.g., 110A-110N) and more or less server computing devices 112 than is illustrated. Each computing device 110 can be any type of suitable computing device, such as a mobile phone, desktop computer, a tablet computer, a laptop computer, a wearable computing device such as eyewear, a watch or other piece of jewelry, or clothing that incorporates a computing device. It is appreciated that each computing device 110 (e.g., 110A-110N) can be used by a respective user 115A-115N.

The outcome prediction platform 100 is executed by the computing device 110. The following description will be specific to the computing device 110, however, it will be appreciated that a plurality of computing devices 110A-110N used by a corresponding plurality of users 115A-115N collectively cooperate in the computing system 10 as will become appreciated herein. In particular, each user 115A-115N can interact with their computing devices 110A-110N and provide real time feedback on predicted outcomes of event market data. These individual feedbacks contribute to an overall user sentiment that can be aggregated in real time and displayed as rendered graphics on a visual display of the computing device 115A-115N from one or more of the users 115A-115N. The sentiment can be represented as a value or score (such as a percentage of liked or disliked) next to the predicted outcome of event market data to any user using the outcome prediction platform 100. As such, a user can compare the predicted outcome of an event based on both (1) the event market data (established by a wagering system such as a sportsbook, polling agency, etc.); and (2) the user sentiment score.

The computing device 110 is shown as including a communication device 116, one more processors 120, a memory 124, a graphical user interface or display device 130, and the outcome prediction platform 100. The processor(s) 120 can control the operation of the computing device 110, including implementing at least a portion of the techniques of the present disclosure. The term “processor” as used herein is intended to refer to both a single processor and multiple processors operating together, e.g., in a parallel or distributed architecture.

The communication device 116 can be configured for communication with other devices (e.g., the server computing devices 112 or other computing devices 110) via the network 114. One non-limiting example of the communication device 116 is a transceiver, although other forms of hardware are within the scope of the present disclosure. The memory 124 can be any suitable storage medium (flash, hard disk, etc.) configured to store information. For example, the memory 124 may store a set of instructions that are executable by the processor 120, which causes the computing device 110 to perform operations (e.g., such as the operations of the present disclosure). The display device 130 can display information to a user. In some implementations, the display device 130 can comprise a touch-sensitive display device (such as a capacitive touchscreen and the like), although non-touch display devices are within the scope of the present disclosure

In the example shown, the network 114 can include an external data sender 134, and an external data receiver 138. The outcome prediction platform 100 can generally include a user sentiment data collection module 200, an event data collection module 300, a data storage and processing module 400, an artificial intelligence module 500, and an outcome predictions module 600.

A user 115 communicates with the computing device 110 to interact with event market data. In examples, the event market data can be obtained through the network 114. The external data sender 134 can include a backend service (such as by way of the server computing devices 112) that collects market odds from multiple external sources (e.g., sportsbooks or data providers) and communicates the collected data to the communication device 116 for the computing device 110 to consume. Similarly, the network 114 can include the external data receiver 138 that receives event and/or prediction output data from the computing device 110.

The user sentiment data collection module 200 collects user interactions with published market odds and records agreement and disagreement and allows for user customized market odds on disagreeable sentiment. The event data collection module 300 collects general event data with published market odds and other relevant event information. The data storage and processing component 400 processes, normalizes, and stores historical and contemporary published odds, user sentiment data, custom odds entries, and event results. The artificial intelligence (AI) module 500 collects and processes the normalized historical and contemporary data and applies machine learning models to identify patterns between user behavior/sentiment and actual event outcomes. The outcome predictions module 600 provides insights or forecasts based on AI model results for upcoming or ongoing events.

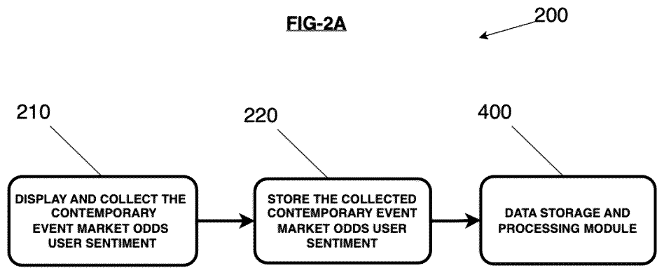

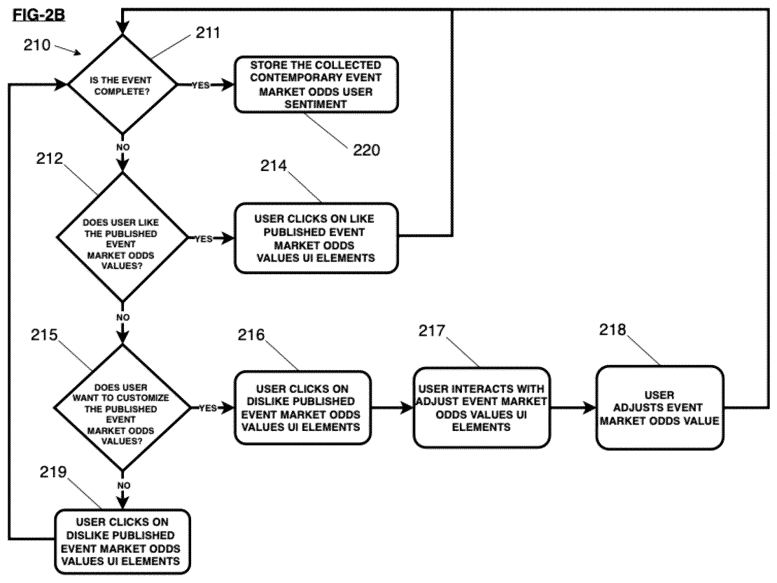

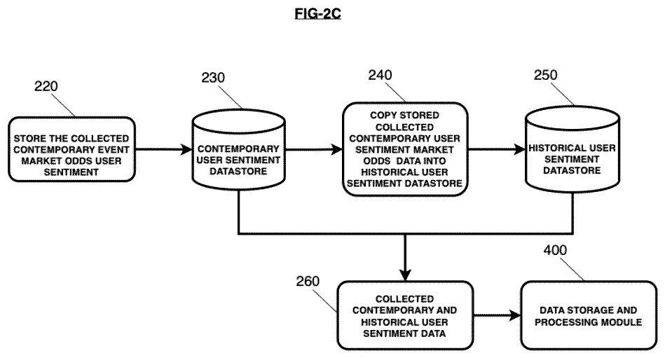

With additional reference now to FIGS. 2A-2C, exemplary steps implemented by the user sentiment data collection module 200 for collecting and submitting user sentiment will be described. At 210, the user is presented with a list of upcoming events along with published market odds. Each event can contain multiple wager types (e.g., outcome-based, margin-based, or proposition-style scenarios). The user sentiment data collection module 200 collects the user sentiment entered by the user. At 220, the user sentiment data collection module 200 stores the collected contemporary event market odds user sentiment data entered by the user.

The user sentiment submission process can include steps 211 to 219 illustrated in FIG. 2B. At 211 control determines whether the event is complete. If the event is complete, control stores the collected contemporary event market odds user sentiment data entered by the user at 220. If the event is not complete, control determines whether the user would like the published event market odd values at 212. If the user would like the published event market odd values, the user selects (e.g., clicks) a user interface (UI) indicative of wanting the published event marked odds values at 214.

If the user does not want the published event marked odd values at 212, control determines whether the user wants to customize the published event marked odds values at 215. If the user would like to customize the published event market odds values at 215, the user selects (e.g., clicks) a UI indicative of disliking published event market odds values at 216. The user interacts with a UI indicative of adjusting market odds values at 217. At 218, the user adjusts the event marked odds value based on the disliked published event market odds. If the user does not want to customize the published event marked odds values at 215, the user selects (e.g., clicks) a UI indicative of disliking the published event market odds values.

For any given market, the user may either agree with published odds indicating agreement with the given valuation submission or disagree on the published odds indicating disagreement with the published odds. An option is provided to create a custom market valuation submission. When a user chooses to disagree, they may submit a custom set of odds based on their own valuation of the event outcome.

With particular reference to FIG. 20, the user sentiment data collection module 200 stores the captured contemporary user sentiment data 220 in the contemporary user sentiment data store 230. When the event(s) complete, the user sentiment data collection module 200 copies the captured contemporary user sentiment data to the historical user sentiment data store at 240. The user sentiment data collection module 200 stores the historic user sentiment data at a historical user sentiment data store 250. At 260, the user sentiment data collection module 200 captures the stored contemporary and historical user sentiment data. The data is stored at the data storage and processing module 400.

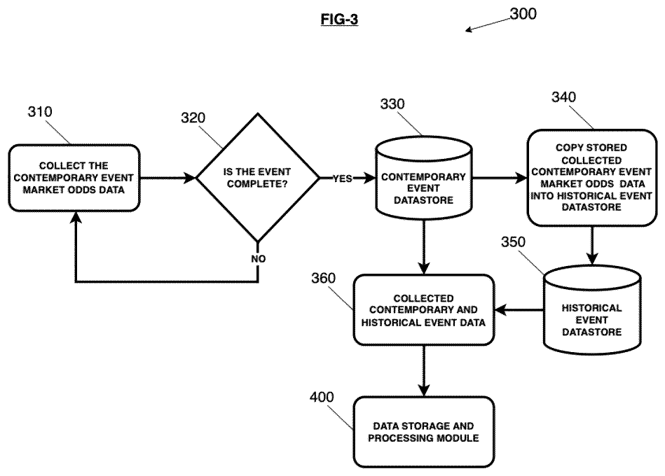

With particular reference to FIG. 3, the event data collection module 300 collects all pre-start and post-start event contemporary data including published odds, event information, and event results (win/loss, score, etc.) at 310. At 320 control determines whether the event has completed. If the event has not completed, control loops to 310. If the event has completed, the system stores the collected event data in the contemporary event datastore at 330. At 340, the event data collection module 300 copies the stored contemporary event data into the historical event datastore. A historical event datastore 350 holds the historical contemporary event data. At 360, the event data collection module 300 collects the contemporary and historical event data and outputs it to the data storage and processing module 400.

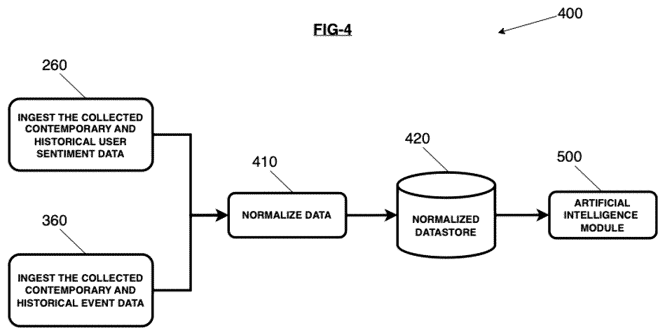

With additional reference now to FIG. 4, exemplary steps implemented by the data storage and processing module 400 will be described. At 260, the data storage and processing module 400 ingests the collected contemporary and historical user sentiment data. At 360, the data storage and processing module 400 ingests the collected contemporary and historical event data. At 410, the data storage and processing module 400 normalizes the ingested data by mapping data formats to a unified model and aligning outcome values to common categories. It then weights data based on user activity level, accuracy, or community ranking. The normalized data is stored in the normalized datastore 420. The normalized datastore 420 is where the system stores the normalized data for the artificial intelligence module 500.

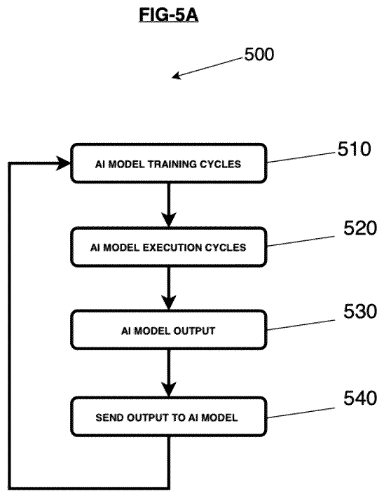

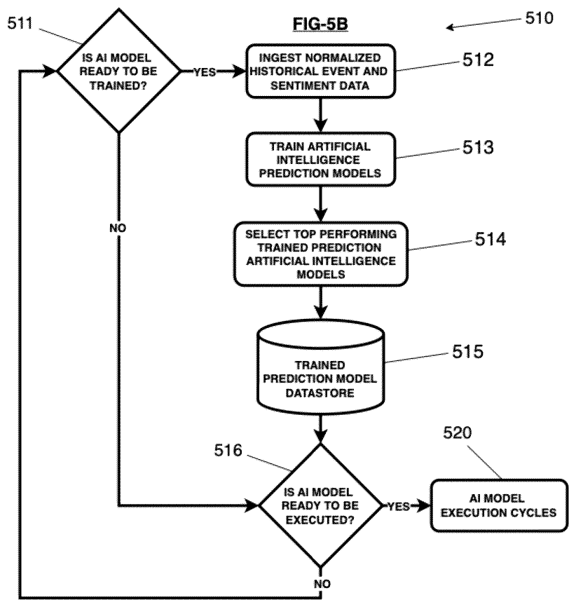

With additional reference now to FIGS. 5A-50, exemplary steps implemented by the artificial intelligence (AI) module 500 will be described. At 510, the AI model training cycles. At 511, control determines whether the AI model is ready to be trained. If not, control loops to 516. If the AI model is ready to be trained, the AI module 500 ingests the normalized historical event and sentiment data. At 512, the AI module 500 ingests the normalized historical event sentiment data. At 513, the AI module 500 trains the artificial intelligence prediction models. At 514, the AI module 500 selects the top performing trained artificial intelligence prediction model(s). The trained prediction model datastore 515 stores the trained AI models and top performing model(s) data. At 516, the AI module 500 determines whether the AI model is ready to be executed. If yes, the AI module 500 executes the AI trained models at 520.

At 521, the AI module 500 determines whether the event is complete. If the event is complete, the AI module 500 sends the model output to the AI training model at 540 and to the outcome predictions module 600. If the AI module 500 determines that the event is not complete, the AI module 500 ingests the normalized contemporary event and user sentiment data at 522. At 523, the AI module 500 executes the trained prediction models with the ingested normalized contemporary event and sentiment data. At 530, the AI model is output from the execution events. The AI model output 530 is then stored as the results and data in the AI model output datastore 532. In particular, the data from the AI model execution events is stored at the AI output model datastore 532. At 540, the AI module sends the AI output model back to the AI training cycles for ingestion into the outcome predictions module 600.

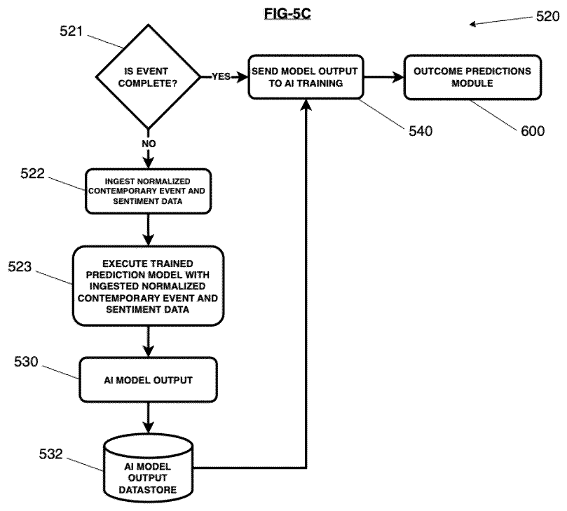

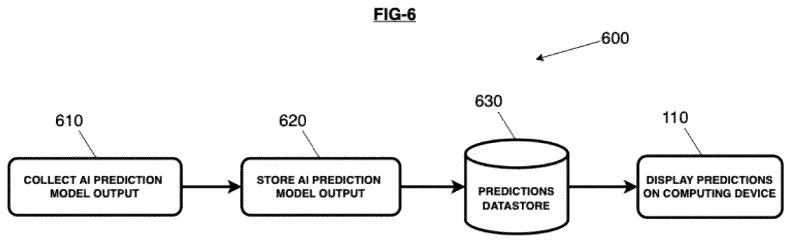

With additional reference now to FIG. 6, exemplary steps implemented by the outcome predictions module 600 will be described. At 610, the outcome predictions module 600 collects the AI prediction model data. At 620, the outcome predictions module 600 stores the AI prediction model output data into the predictions datastore 630. In examples, the predictions datastore 630 stores the AI model output predictions for ingestion to the computing device to display to the end user. In examples, the computing device 100 displays the AI model predictions as rendered graphics on the visual display 130 (FIG. 1).

According to various examples, the computing system 10 comprises a multi-platform application (operable via mobile and desktop) that enables a plurality of users 115A-115N to engage with market odds for a variety of event types. These events may include, but are not limited to, sporting competitions, political races, entertainment awards, financial forecasts, and other competitive or measurable occurrences.

Users 115A-115N interact with published or generated event market odds through a user interface (e.g., respective display 130) that allows them to express sentiment (and view sentiment of other users) regarding the validity or favorability of specific outcome values. Sentiment may be expressed through interface elements such as “agree/disagree,” “like/dislike,” or any other contextually suitable mechanism. The system is designed to accommodate flexible UI implementations while maintaining consistency in the underlying data structure.

By way of example only, the system 10 can process events (e.g., outcomes related to events) such as, but not limited to: (1) Standard outcome-based events, such as predicting a winner of a match or election; (2) Proposition markets, which relate to specific statistics or thresholds (e.g., “Will Player X score more than 20 points?” or “Will Stock Y close above $150?”); (3) Parlay or multi-leg events, which combine multiple individual outcomes into a single dependent outcome (e.g., “Team A wins and Player B scores and Game Total is over 200”); and (4) Prediction markets, to allow users to buy and sell shares in the outcomes of events—such as political elections—where the price reflects the crowd's perceived probability of each outcome.

When a user expresses disagreement with an existing market valuation, the system 10 optionally allows them to create custom odds, modifying one or more parameters such as implied probability, point spread, statistical thresholds, or outcome dependencies. These user-defined odds reflect the individual's perspective and can be shared, stored, and analyzed independently from the originally published values.

Each interaction—whether sentiment submission or custom odds creation—is captured and stored in a centralized repository along with associated metadata, including event identifier, timestamp, user identifier, market type, and any relevant modifications.

The system includes a data normalization layer, which processes: (1) Standardization of market odds formats (e.g., decimal, moneyline, or implied probability); (2) Classification of sentiment as binary, weighted, or scaled input; and (3) Alignment of outcomes and markets into a common data structure to support model training.

Once normalized, the data is passed to the AI module 500, which may include one or more supervised learning models such as logistic regression, support vector machines, decision trees, ensemble models (e.g., random forests), or deep learning architectures. These models analyze historical sentiment patterns, user accuracy, and event outcome correlations to generate predictive insights.

The outputs of the computing system 10 can be displayed as rendered graphics on the display 130 and may include: (1) Predicted probabilities for single or composite outcomes; (2) Confidence scores associated with the AI's recommendations; (3) Community sentiment trends and their historical performance; and (4) Alerts or overlays highlighting deviations between user sentiment and published market odds.

In some embodiments, the computer system 10 includes a ranking or influence system to reward users whose historical sentiment and custom odds have aligned accurately with outcomes. These users (e.g., 115A-115N) may receive visibility on leaderboards, weightier influence in AI training models, or incentives tied to community engagement.

The visual display 130 can include a graphical user interface that may present: (1) Event cards with outcome options and market odds; (2) Sentiment interaction buttons for each outcome; (3) Custom odds sliders, toggles, or input fields for user adjustment; (4) Visualizations such as sentiment bars, prediction charts, and parlay builders; and (5) Results feedback for closed events, showing prediction vs. actual outcomes.

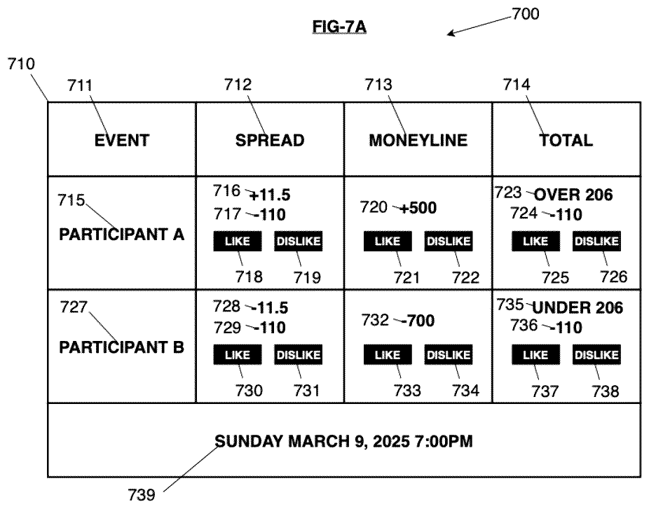

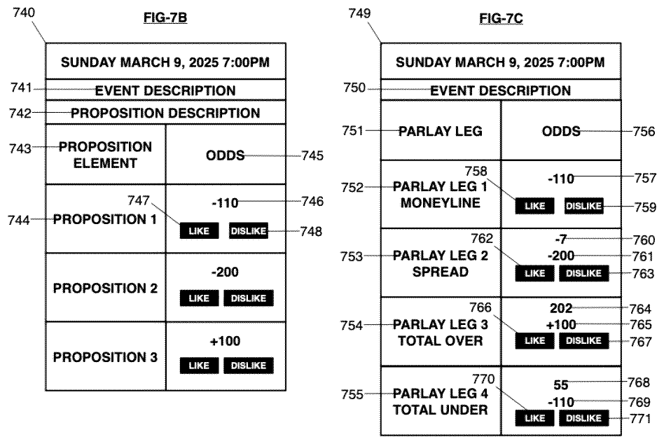

FIG. 7A is an exemplary visual display and user interface 130 that includes rendered graphics 700 including the pre-start event market odds details with user sentiment visual elements not submitted. The visual display 130 presents, as rendered graphics 710, the published event market odds data with exemplary user sentiment not submitted. 711 indicates the name of the event. 712 indicates the published non-customized spread market odds value column for the event. 713 indicates the published non-customized moneyline market odds value column for the event. 714 indicates the published non-customized total (over/under) market odds value column for the event. 715 indicates the first participant of the event. As used herein “participant” is used to mean a participant of the event (e.g., team A) being wagered on (as opposed to the user 115A-115N doing the wagering on the event).

716 indicates the first participant's spread point market odds value for the event. 717 indicates the first participant's spread price market odds value for the event. 718 indicates the graphical user interface element that represents an agreeable market odds user sentiment submission for the first participant's spread point market odds value for the event. 719 indicates the graphical user interface element that represents a disagreeable market odds user sentiment submission for the first participant's spread point market odds value for the event. 720 indicates the first participant's moneyline price market odds value for the event. 721 indicates the graphical user interface element that represents an agreeable user sentiment submission for the first participant's published non-customized moneyline price market odds value for the event. 722 indicates the graphical user interface element that represents a disagreeable user sentiment submission for the first participant's published non-customized moneyline price market odds value for the event.

723 indicates the event total over point market odds value. 724 indicates the event total over price market odds value. 725 indicates the graphical user interface element that represents an agreeable user sentiment submission for the first participant's published non-customized total over market odds value for the event. 726 indicates the graphical user interface element that represents a disagreeable user sentiment submission for the first participant's published non-customized total over market odds value for the event.

727 indicates the second participant of the event, usually going against or versus the first participant, and is usually referred to as the home or host participant. 728 indicates the second participant's spread point market odds value for the event. 729 indicates the second participant's spread price market odds value for the event. 730 indicates the graphical user interface element that represents an agreeable market odds user sentiment submission for the second participant's spread point market odds value for the event. 731 indicates the graphical user interface element that represents a disagreeable market odds user sentiment submission for the second participant's spread point market odds value for the event. 732 indicates the second participant's moneyline price market odds value for the event. 733 indicates the graphical user interface element that represents an agreeable user sentiment submission for the second participant's published non-customized moneyline price market odds value for the event.

734 indicates the graphical user interface element that represents a disagreeable user sentiment submission for the second participant's published non-customized moneyline price market odds value for the event. 735 indicates the event total under point market odds value. 736 indicates the event total under price market odds value. 737 indicates the graphical user interface element that represents an agreeable user sentiment submission for the second participant's published non-customized total under market odds value for the event. 738 indicates the graphical user interface element that represents a disagreeable user sentiment submission for the second participant's published non-customized total under market odds value for the event. 739 indicates the start date and time of the event.

FIG. 7B is an exemplary visual display and user interface 130 that includes rendered graphics 740 including the pre-start event details for the proposition market odds with user sentiment visual elements not submitted. The visual display 130 presents, as rendered graphics, the event description 741, the event proposition description 742, the proposition element name 743, the proposition market odds value row 744 for each proposition element. 745 indicates the first proposition element market odds description. 746 indicates the proposition element market odds price value. 747 indicates the “like” graphical user interface element that represents an agreeable proposition market odd user sentiment submission for the event. 748 indicates the “dislike” graphical user interface element that represents a disagreeable proposition market odd user sentiment submission for the event.

FIG. 7C is an exemplary visual display and user interface 130 that includes rendered graphics 749 including the pre-start event details for multiple concurrent event selections, or parlays, market odds with user sentiment visual elements not submitted. 750 indicates the event description. 751 indicates the event parlay description. 752 indicates an exemplary moneyline parlay market odds type element. 753 indicates an exemplary spread parlay market odds type element. 754 indicates an exemplary total over parlay market odds type element. 755 indicates an exemplary total under parlay market odds type element. 756 indicates the parlay elements market odds description. 757 indicates the moneyline parlay element market odds price value.

758 indicates the “like” graphical user interface element that represents an agreeable moneyline parlay market odd user sentiment submission for the event. 759 indicates the “dislike” graphical user interface element that represents a disagreeable moneyline parlay market odd user sentiment submission for the event. 760 indicates the spread parlay element market odds point value. 761 indicates the spread parlay element market odds price value. 762 indicates the “like” graphical user interface element that represents an agreeable spread parlay market odd user sentiment submission for the event. 763 indicates the “dislike” graphical user interface element that represents a disagreeable spread parlay market odd user sentiment submission for the event. 764 indicates the total over parlay element market odds point value. 765 indicates the total over parlay element market odds price value.

766 indicates the “like” graphical user interface element that represents an agreeable total over parlay market odd user sentiment submission for the event. 767 indicates the “dislike” graphical user interface element that represents a disagreeable total over parlay market odd user sentiment submission for the event. 768 indicates the total under parlay element market odds point value. 769 indicates the total under parlay element market odds price value. 770 indicates the “like” graphical user interface element that represents an agreeable total under parlay market odd user sentiment submission for the event. 771 indicates the “dislike” graphical user interface element that represents a disagreeable total under parlay market odd user sentiment submission for the event.

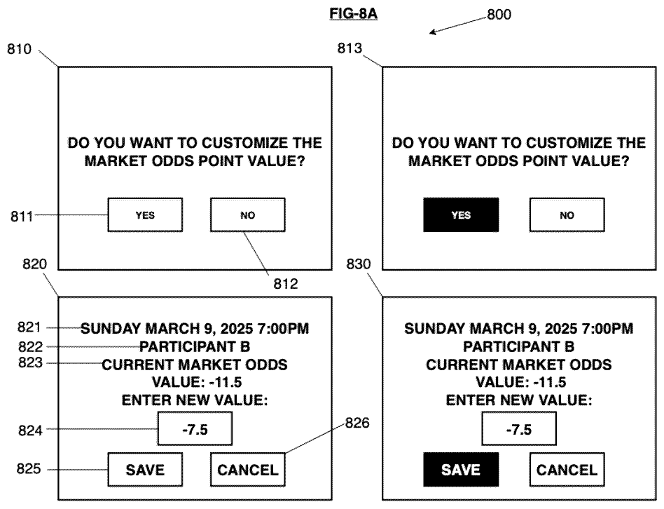

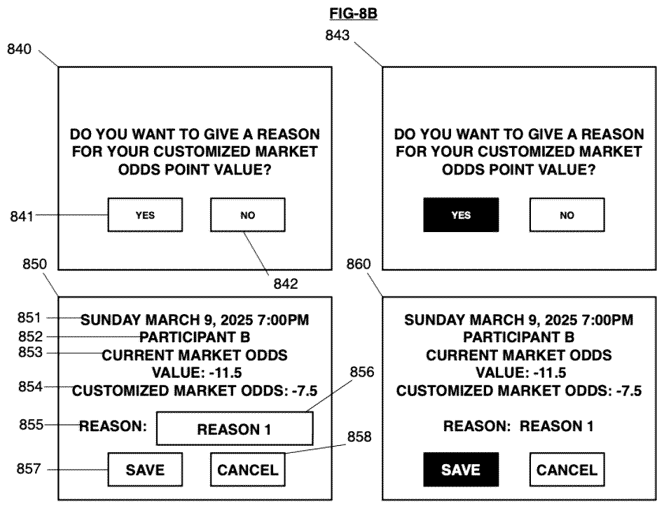

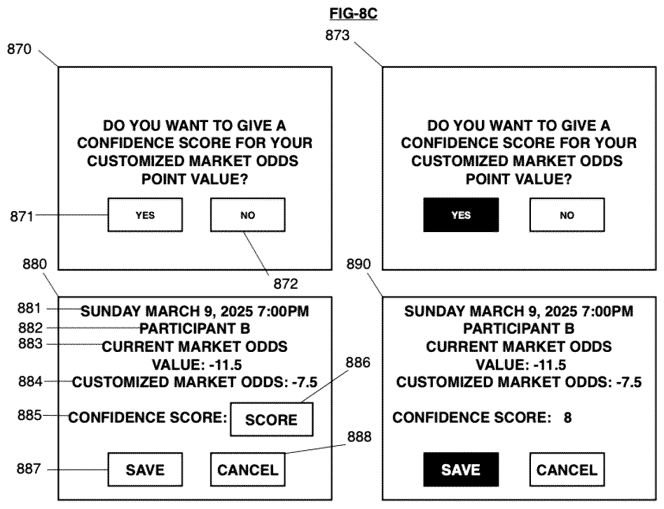

FIG. 8A is an exemplary visual display and user interface 130 that includes rendered graphics 800 including a user interface that displays and enables the customize event market odds during a disagreeable user sentiment submission. 810 indicates an exemplary pre-event visual display requesting if user wants to change the point market odds value with a disagreeable or dislike submitted sentiment. 811 indicates a “yes” or confirmation visual display element or button. If the user submits this visual display element, they will be asked to enter a new value at 824.

812 indicates a “no” or cancel visual display element or button that will cancel out the customize action. 813 indicates an exemplary pre-event visual displaying a user submitting a yes or confirmation that they want to customize or change the event point market odds value. 820 indicates an exemplary pre-event visual displaying the elements required for a user to customize or change the event point market odds value. 821 indicates the pre-start visual displaying the current event start date and time. 822 indicates the pre-start visual displaying the participant of the current event. 823 indicates the pre-start visual displaying the current event point market odds value. 824 indicates an exemplary visual element displaying where the user will enter their new customized point market odds value. 825 indicates a “save” or confirmation visual display element or button. If a user submits this visual display element, they will be submitting their customed point market odds value. 826 indicates a “no” or cancel visual display element or button that will cancel out the customize action. 830 indicates an exemplary visual displaying the user clicking save to submit their customized event spread point market odds value.

FIG. 8B is an exemplary visual display 130 that includes rendered graphics 840 including the pre-event visual display requesting if the user wants to add a reason for their market odds point customization value with a disagreeable or dislike submitted sentiment. 841 indicates a “yes” or confirmation visual display element or button to confirm. 842 indicates a “no” or cancel visual display element or button that will cancel out the action. 843 indicates an exemplary pre-event visual displaying a user submitting a “yes” or confirmation that they want to enter a reason for their customize or change the event point market odds value.

850 indicates an exemplary pre-event visual displaying the elements required for a user to enter a reason for their event point market odds value customization. 851 indicates the pre-start visual displaying the current event start date and time. 852 indicates the pre-start visual displaying the participant of the current event. 853 indicates the pre-start visual displaying the current event point market odds value. 854 indicates an exemplary visual element displaying the user's customized event point market odds value. 855 indicates where the user enters their reason for customization. If the user submits this visual element, they will be asked to enter a new value at 856. 856 indicates a graphical user interface element such as a textbox or a drop-down item listing the reason(s) for the point customization.

857 indicates a “save” or confirmation visual display element or button. If user submits this visual display element, they will be submitting their customed point market odds value reason. 858 indicates a “no” or cancel visual display element or button that will cancel out the customize action. 860 indicates an exemplary visual displaying the user clicking save to submit their customized event spread point market odds value reason.

FIG. 8C is an exemplary visual display 130 that includes rendered graphics 870 including exemplary pre-event visual display requesting if user wants to add a confidence score for their market odds point customization value with a disagreeable or dislike submitted sentiment. 871 indicates a “yes” or confirmation visual display element or button to confirm. 872 indicates a “no” or cancel visual display element or button that will cancel out the action. 873 indicates an exemplary pre-event visual displaying a user submitting a yes or confirmation that they want to enter a confidence score for their customize or change the event point market odds value.

880 indicates an exemplary pre-event visual displaying the elements required for a user to enter a confidence score for their event point market odds value customization. 881 indicates the pre-start visual displaying the current event start date and time. 882 indicates the pre-start visual displaying the participant of the current event. 883 indicates the pre-start visual displaying the current event point market odds value. 884 indicates an exemplary visual element displaying the user's customized event point market odds value. 885 indicates where the user enters their confidence score for customization.

If the user submits this visual display element, they will be asked to enter a new value at 886. 886 indicates a graphical user interface element such as a textbox or a drop-down item listing the confidence score(s) for the point customization. 887 indicates a save or confirmation visual display element or button. If the user submits this visual display element, they will be submitting their customed point market odds value confidence score. 888 indicates a “no” or cancel visual display element or button that will cancel out the customize action. 890 indicates an exemplary visual displaying the user clicking save to submit their customized event spread point market odds value confidence score.

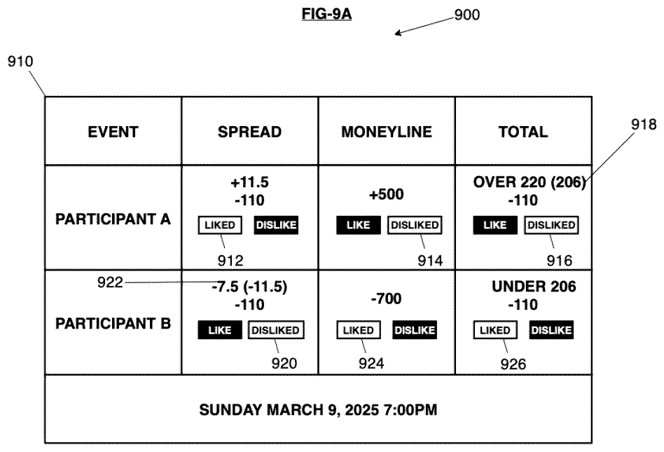

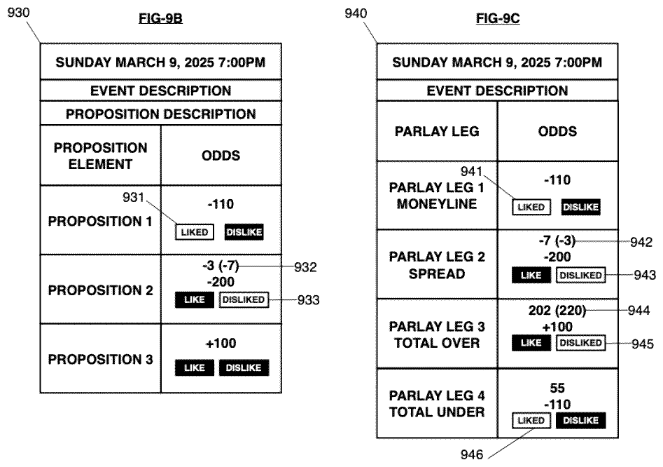

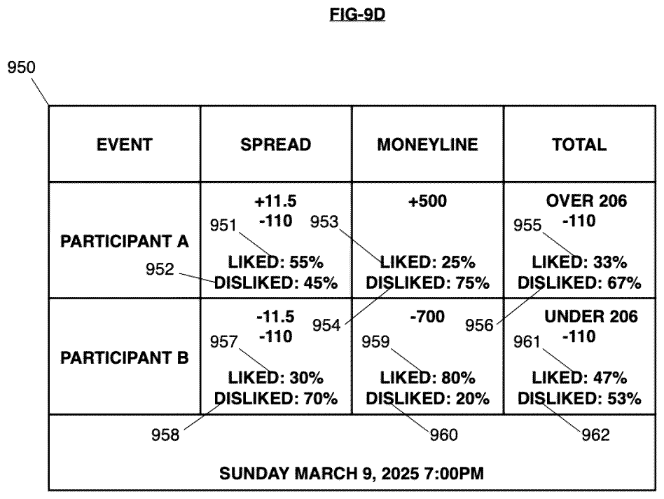

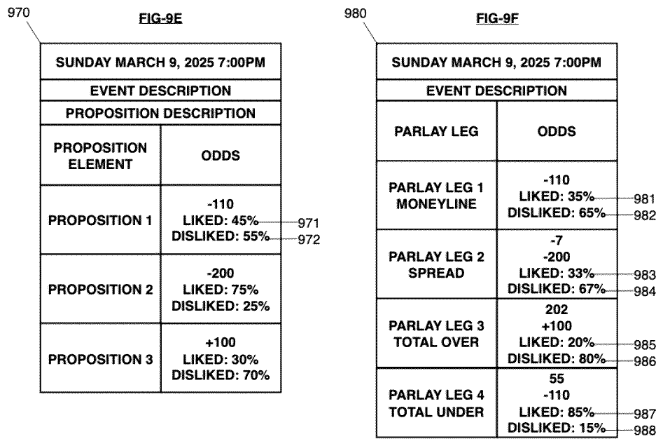

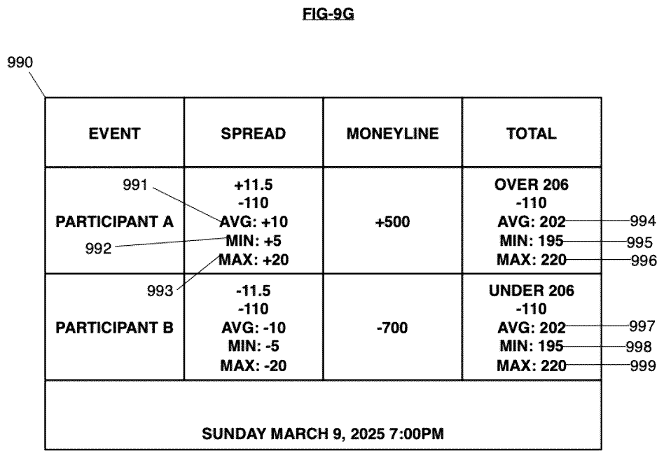

FIG. 9A is an exemplary visual display and user interface 130 that includes rendered graphics 900 including the post-start event details for the proposition market odds with total user sentiment visual elements submitted. 910 indicates an exemplary graphical user interface that displays the post-start event market odds details with customized user sentiment visual elements submitted for a given user. 912 indicates the graphical user interface element displaying an agreeable spread point market odds user sentiment submission for the first participant. 914 indicates the graphical user interface element displaying a disagreeable moneyline market odds user sentiment submission for the first participant. 916 indicates the graphical user interface element displaying a disagreeable total over market odds user sentiment submission.

918 indicates the graphical user interface element displaying the user's customized total over point value for their disagreeable user sentiment submission. The original value is in parentheses. 920 indicates the graphical user interface element displaying a disagreeable spread point market odds user sentiment submission for the second participant. 922 indicates the graphical user interface element displaying the user's customized spread point value for their disagreeable user sentiment submission for the second participant. The original value is in parentheses. 924 indicates the graphical user interface element displaying an agreeable moneyline market odds user sentiment submission for the second participant. 926 indicates the graphical user interface element displaying an agreeable total under point market odds user sentiment submission.

FIG. 9B is an exemplary visual display and user interface 130 that includes rendered graphics 930 including the post-start event details for the proposition market odds with user sentiment visual elements submitted for a given user. 931 indicates the agreeable (“like” or similar) visual element is updated when user submits agreeable sentiment for the published proposition market odds value for the event. 932 indicates the user's customized market odds value from a disagreeable proposition sentiment submission. The original value in parentheses. 933 indicates the disagreeable (“dislike” or similar) visual element is updated when user submits disagreeable sentiment for the published proposition market odds value for the event.

FIG. 9C is an exemplary visual display and user interface 130 that includes rendered graphics 940 including the post-start event details for the parlay market odds with user sentiment visual elements submitted for a given user. 941 indicates the agreeable (“like” or similar) visual element is updated when user submits agreeable parlay sentiment for the published moneyline market odds value for the event. 942 indicates the user's customized market odds value from a disagreeable spread point market odds parlay sentiment submission. The original value in parentheses. 943 indicates the disagreeable (“dislike” or similar) visual element is updated when user submits disagreeable parlay sentiment for the published spread point market odds value for the event. 944 indicates the user's customized market odds value from a disagreeable total over point market odds parlay sentiment submission. The original value in parentheses. 945 indicates the disagreeable (“dislike” or similar) visual element is updated when user submits disagreeable parlay sentiment for the published total point parlay market odds value for the event. 946 indicates the agreeable (“like” or similar) visual element is updated when user submits agreeable parlay sentiment for the published total under parlay market odds value for the event.

FIG. 9D is an exemplary visual display and user interface 130 that includes rendered graphics 950 including the post-start event market odds details with total user sentiment visual elements submitted related to both the first and second participant. 951 indicates the event liked user sentiment value for the spread point market odds for the first participant. 952 indicates the event disliked user sentiment value for the spread point market odds for the first participant. 953 indicates the event liked user sentiment value for the moneyline market odds for the first participant. 954 indicates the event disliked user sentiment value for the moneyline market odds for the first participant. 955 indicates the event liked user sentiment value for the total over (for the event) point market odds. 956 indicates the event disliked user sentiment value for the total over market odds.

957 indicates the event liked user sentiment value for the spread point market odds for the second participant. 958 indicates the event disliked user sentiment value for the spread point market odds for the second participant. 959 indicates the event liked user sentiment value for the moneyline market odds for the second participant. 960 indicates the event disliked user sentiment value for the moneyline market odds for the second participant. 961 indicates the event liked user sentiment value for the total under point market odds. 962 indicates the event disliked user sentiment value for the total under market odds.

FIG. 9E is an exemplary visual display and user interface 130 that includes rendered graphics 970 including the post-start event details for the proposition market odds with total user sentiment visual elements submitted. 971 indicates the event liked user sentiment value for the proposition element market odds. 972 indicates the event disliked user sentiment value for the proposition element market odds.

FIG. 9F is an exemplary visual display and user interface 130 that includes rendered graphics 980 including the post-start event details for the parlay market odds with total user sentiment visual elements submitted. 981 indicates the event liked user sentiment value for the moneyline parlay leg element market odds. 982 indicates the event disliked user sentiment value for the moneyline parlay leg element market odds. 983 indicates the event liked user sentiment value for the spread parlay leg element market odds. 984 indicates the event disliked user sentiment value for the spread parlay leg element market odds. 985 indicates the event liked user sentiment value for the total over parlay leg element market odds. 986 indicates the event disliked user sentiment value for the total over parlay leg element market odds. 987 indicates the event liked user sentiment value for the total under parlay leg element market odds. 988 indicates the event disliked user sentiment value for the total under parlay leg element market odds.

FIG. 9G is an exemplary visual display and user interface 130 that includes rendered graphics 990 including the post-start event market odds customized spread, total over, and total under point details including the average, minimum, and maximum values for each event participant values. 991 indicates the average customized spread point submitted by all users for this event market odds type. 992 indicates the minimum customized spread point submitted by all users for this event market odds type. 993 indicates the maximum customized spread point submitted by all users for this event market odds type.

994 indicates the average customized total over point submitted by all users for this event market odds type. 995 indicates the minimum customized total over point submitted by all users for this event market odds type. 996 indicates the maximum customized total over point submitted by all users for this event market odds type. 997 indicates the average customized total under point submitted by all users for this event market odds type. 998 indicates the minimum customized total under point submitted by all users for this event market odds type. 999 indicates the maximum customized total under point submitted by all users for this event market odds type. It will be appreciated that while the views in FIGS. 9A-9G have been described as “post-start” event details, the views may also be presented as pre-start event details such as for comparison purposes (e.g., for comparing sentiment and/or AI predictions).

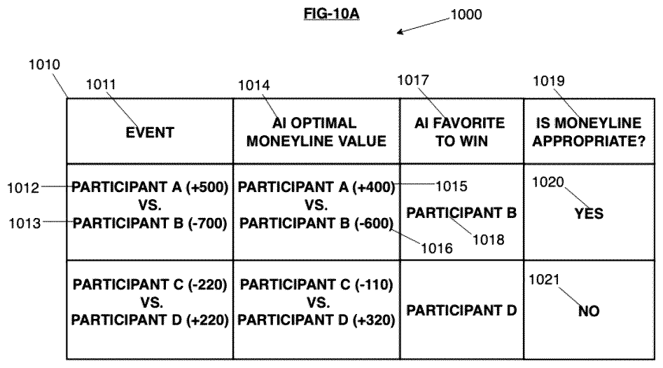

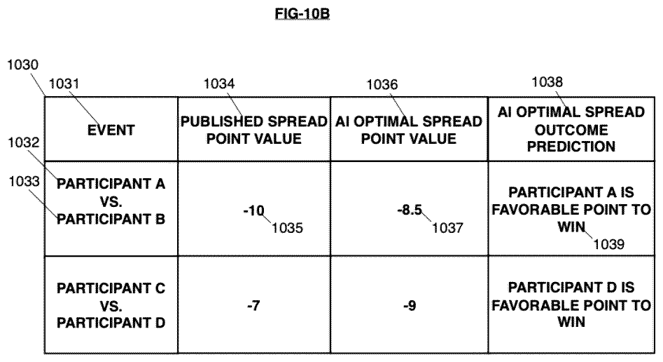

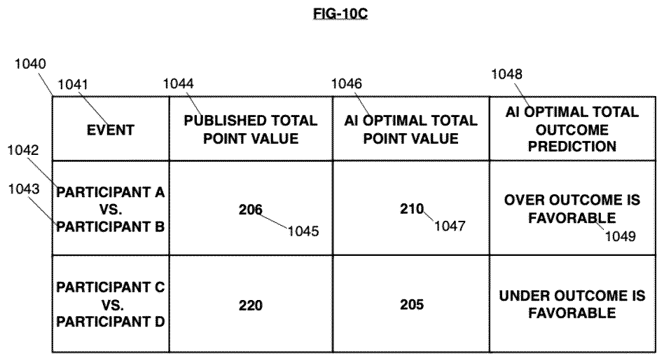

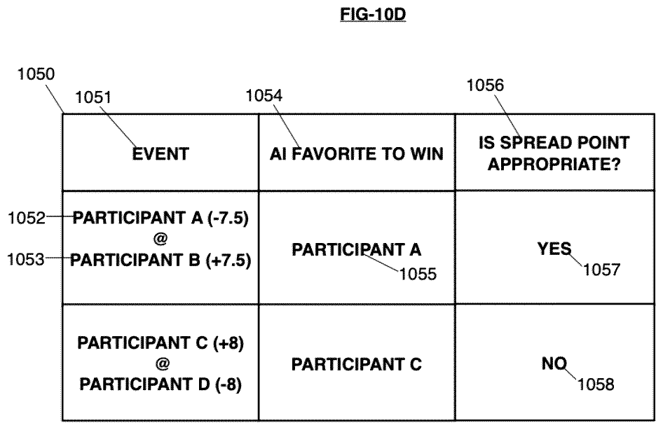

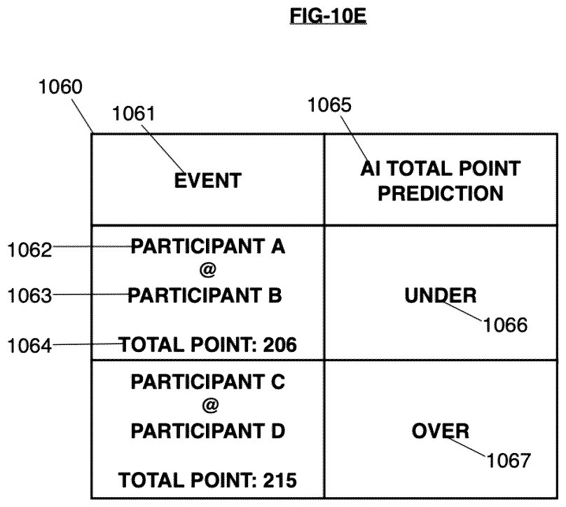

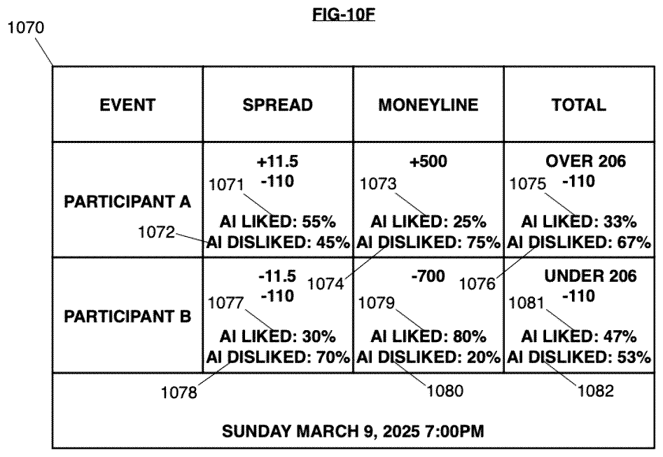

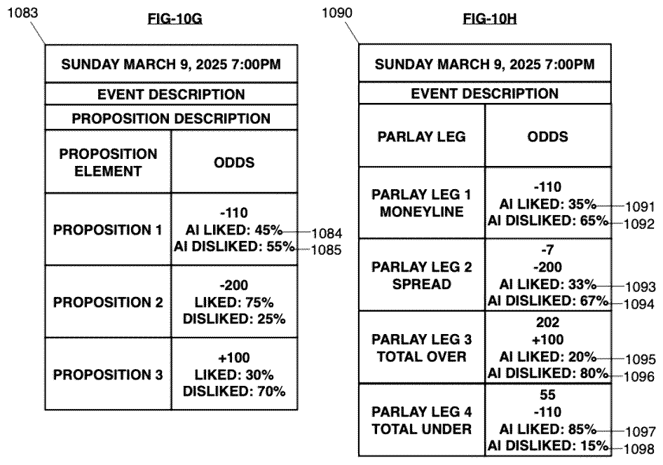

FIG. 10A is an exemplary visual display and user interface 130 that includes rendered graphics 1000 including the artificial intelligence (AI) predictions based on the AI model training and execution of the total collected historical and contemporary user sentiment and event data for a pre-start event. 1010 indicates the exemplary graphical user interface that displays the artificial intelligence (AI) predictions of the optimal moneyline market odds values, who the favorite of the participants will win, and is the moneyline market odds appropriate based on the AI model training and execution of the total collected historical and contemporary user sentiment and event data for a pre-start event.

1011 indicates the name of the event. 1012 indicates the first participant moneyline market odds value. 1013 indicates the second participant moneyline market odds value. 1014 indicates the AI optimal moneyline market odds value prediction column. 1015 indicates the first participant AI predicted optimal moneyline market odds value. 1016 indicates the second participant AI predicted optimal moneyline market odds value. 1017 indicates the AI favorite to win prediction column. 1018 indicates the displayed AI favorite to win between the first participant and the second participant for the given event. 1019 indicates the moneyline market odds values appropriate prediction column. 1020 indicates the displayed AI prediction to if the moneyline market odds value is appropriate, confirming it is appropriate. 1021 indicates the displayed AI prediction to if the moneyline market odds value is appropriate confirming it is not appropriate.

FIG. 10B is an exemplary visual display and user interface 130 that includes rendered graphics 1030 including the artificial intelligence (AI) predictions of the optimal spread point market odds values and the optimal spread outcome prediction based on the AI model training and execution of the total collected historical and contemporary user sentiment and event data for a pre-start event. 1031 indicates the name of the event. 1032 indicates the first participant of the event. 1033 indicates the second participant of the event. 1034 indicates the published spread point market odds for the event prediction column. 1035 indicates the published spread point market odds for the event. 1036 indicates the AI optimal spread point market odds value prediction column. 1037 indicates the AI optimal spread point market odds value prediction for the event. 1038 indicates the AI optimal spread outcome prediction column.

1039 indicates the AI prediction display of which participant's favorable point to win the event.

FIG. 10C is an exemplary visual display and user interface 130 that includes rendered graphics 1040 that displays the artificial intelligence (AI) predictions of the optimal total point market odds values and the optimal total outcome prediction based on the AI model training and execution of the total collected historical and contemporary user sentiment and event data for a pre-start event. 1041 indicates the name of the event. 1042 indicates the first participant of the event. 1043 indicates the second participant of the event. 1044 indicates the published total point market odds for the event prediction column. 1045 indicates the published total point market odds for the event. 1046 indicates the AI optimal total point market odds value prediction column. 1047 indicates the AI optimal total point market odds value prediction for the event. 1048 indicates the AI optimal total outcome prediction column. 1049 indicates the AI prediction display of whether the favorable outcome will be over or under.

FIG. 10D is an exemplary visual display and user interface 130 that includes rendered graphics 1050 that displays the artificial intelligence (AI) predictions of which event participant is favorite to win and is the event spread point market odds value appropriate based on the AI model training and execution of the total collected historical and contemporary user sentiment and event data for a pre-start event. 1051 indicates the name of the event. 1052 indicates the first participant's published spread point market odds value of the event. 1053 indicates the second participant's published spread point market odds value of the event. 1054 indicates the predicted AI favorite to win column. 1055 indicates the displayed AI favorite to win for the given event. 1056 indicates the is spread point appropriate prediction column. 1057 indicates a prediction display that the spread point market odds value is appropriate. 1058 indicates a prediction display that the spread point market odds value is not appropriate.

FIG. 10E is an exemplary visual display and user interface 130 that includes rendered graphics 1060 that displays the artificial intelligence (AI) prediction of whether the total point market odds will be over or under based on the AI model training and execution of the total collected historical and contemporary user sentiment and event data for a pre-start event. 1061 indicates the name of the event. 1062 indicates the first participant of the event. 1063 indicates the second participant of the event. 1064 indicates the total point market odds for the event. 1065 indicates the displayed AI total point prediction column for the event. 1066 indicates the displayed prediction of the total point prediction for an under outcome. 1067 indicates the displayed prediction of the total point prediction for an over outcome.

FIG. 10F is an exemplary visual display and user interface 130 that includes rendered graphics 1070 that displays the artificial predictions (AI) predictions for pre-start event market odds details with total user sentiment visual elements submitted. 1071 indicates the event AI predicted liked user sentiment value for the spread point market odds for the first participant. 1072 indicates the event AI predicted disliked user sentiment value for the spread point market odds for the first participant. 1073 indicates the event AI predicted liked user sentiment value for the moneyline market odds for the first participant. 1074 indicates the event AI predicted disliked user sentiment value for the moneyline market odds for the first participant. 1075 indicates the event AI predicted liked user sentiment value for the total over point market odds. 1076 indicates the event AI predicted disliked user sentiment value for the total over market odds. 1077 indicates the event AI predicted liked user sentiment value for the spread point market odds for the second participant. 1078 indicates the event AI predicted disliked user sentiment value for the spread point market odds for the second participant. 1079 indicates the event AI predicted liked user sentiment value for the moneyline market odds for the second participant. 1080 indicates the event AI predicted disliked user sentiment value for the moneyline market odds for the second participant. 1081 indicates the event AI predicted liked user sentiment value for the total under point market odds. 1082 indicates the event AI predicted disliked user sentiment value for the total under market odds.

FIG. 10G is an exemplary visual display and user interface 130 that includes rendered graphics 1083 that displays the artificial intelligence (AI) predicted pre-start event details for the proposition market odds with total user sentiment visual elements submitted. 1084 indicates the event AI predicted liked user sentiment value for the proposition element market odds. 1085 indicates the event AI predicted disliked user sentiment value for the proposition element market odds.

FIG. 10H is an exemplary visual display and user interface 130 that includes rendered graphics 1090 that displays the artificial intelligence (AI) predicted pre-start event details for the parlay market odds with total user sentiment visual elements submitted. 1091 indicates the event AI predicted liked user sentiment value for the moneyline parlay leg element market odds. 1092 indicates the event AI predicted disliked user sentiment value for the moneyline parlay leg element market odds. 1093 indicates the event AI predicted liked user sentiment value for the spread parlay leg element market odds. 1094 indicates the event AI predicted disliked user sentiment value for the spread parlay leg element market odds. 1095 indicates the event AI predicted liked user sentiment value for the total over parlay leg element market odds. 1096 indicates the event AI predicted disliked user sentiment value for the total over parlay leg element market odds. 1097 indicates the event AI predicted liked user sentiment value for the total under parlay leg element market odds. 1098 indicates the event AI predicted disliked user sentiment value for the total under parlay leg element market odds. It will be appreciated that while the views in FIGS. 10A-10H have been described as “pre-start” event details, the views may also be presented as post-start event details such as for comparison purposes (e.g., for comparing sentiment and/or AI predictions).

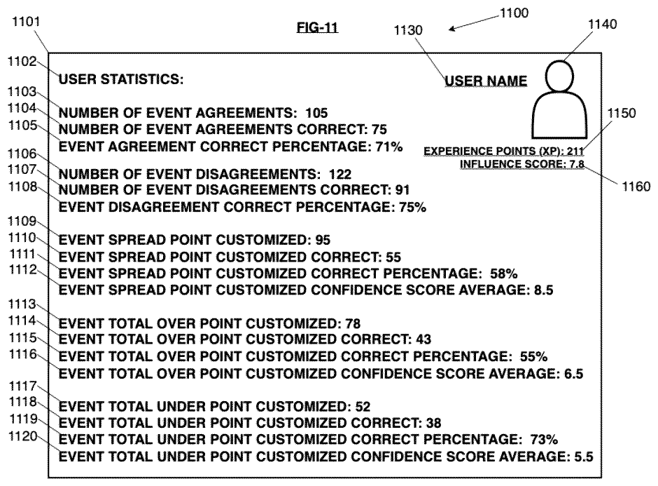

FIG. 11 is an exemplary visual display and user interface 130 that includes rendered graphics 1100 including exemplary statistics 1101 for the user of the present disclosure. 1102 indicates the user statistics header. 1103 indicates the total number of event market odds agreements that the user submitted. 1104 indicates the total number of event market odds agreements that the user got correct. 1105 indicates the total percentage of correct event market odds agreements that the user got correct. 1106 indicates the total number of event market odds disagreements that the user submitted. 1107 indicates the total number of event market odds disagreements that the user got correct. 1108 indicates the total percentage of correct event market odds disagreements that the user got correct. 1109 indicates the total number of customized spread point market odds disagreements that the user submitted.

1110 indicates the total number of customized spread point market odds disagreements that the user got correct. 1111 indicates the total percentage of customized spread point market odds disagreements that the user got correct. 1112 indicates the average confidence score of the customized spread point market odds disagreements that the user got correct. 1113 indicates the total number of customized total over point market odds disagreements that the user submitted. 1114 indicates the total number of customized total over point market odds disagreements that the user got correct. 1115 indicates the total percentage of customized total over point market odds disagreements that the user got correct.

1116 indicates the average confidence score of the customized total over point market odds disagreements that the user got correct. 1117 indicates the total number of customized total under point market odds disagreements that the user submitted. 1118 indicates the total number of customized total under point market odds disagreements that the user got correct. 1119 indicates the total percentage of customized total under point market odds disagreements that the user got correct. 1120 indicates the average confidence score of the customized total under point market odds disagreements that the user got correct. 1130 indicates the user's username. 1140 indicates the user's profile picture. 1150 indicates the user's experience points (xp) number. 1160 indicates the user's influence points number.

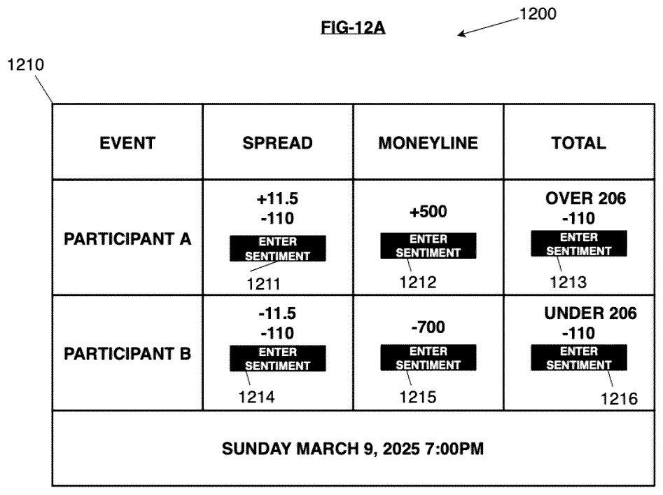

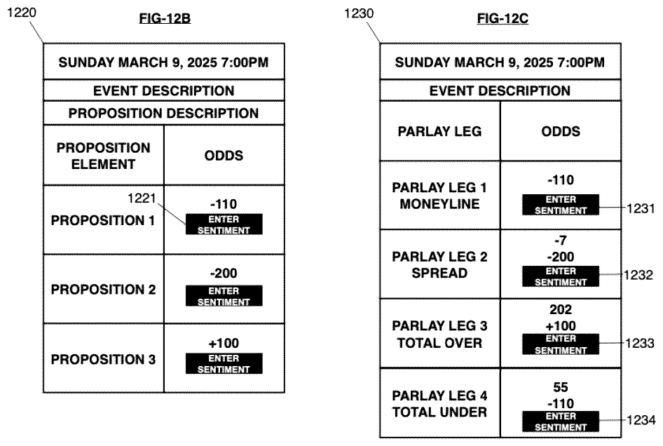

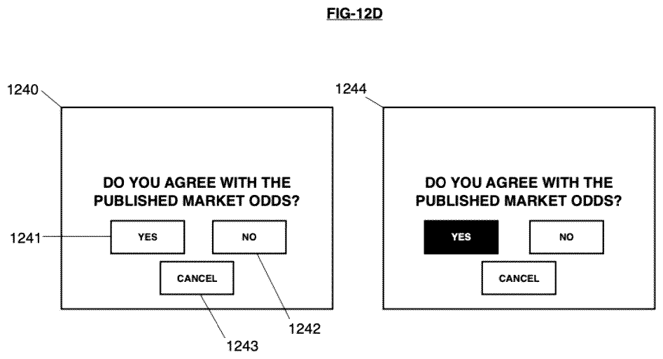

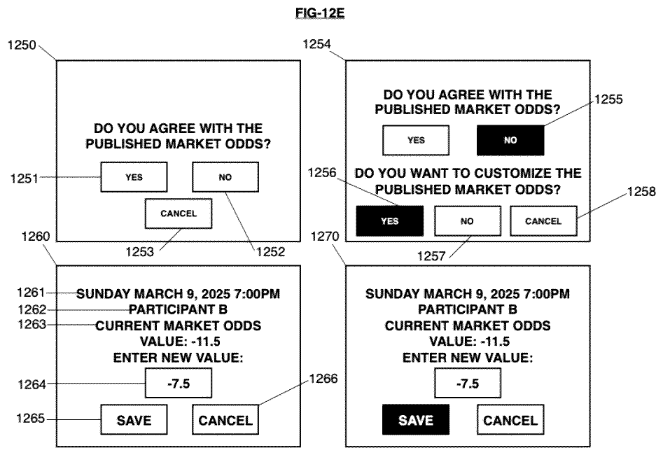

FIG. 12A is an exemplary graphical user interface of the computing device of FIG. 1 shown displaying pre-start event market odds details with user sentiment visual elements not submitted by market odds type. 1210 indicates event visual display 130 that presents the published event market odds data with exemplary user sentiment not submitted by market odds type. 1211 indicates the graphical user interface element that represents how the user will enter their spreads market odds sentiment for the first participant. 1212 indicates the graphical user interface element that represents how the user will enter their moneyline market odds sentiment for the first participant. 1213 indicates the graphical user interface element that represents how the user will enter their total over market odds sentiment. 1214 indicates the second graphical user interface element that represents how the user will enter their spreads market odds sentiment for the second participant. 1215 indicates the second graphical user interface element that represents how the user will enter their moneyline market odds sentiment for the second participant. 1216 indicates the graphical user interface element that represents how the user will enter their total under market odds sentiment.

FIG. 12B is an exemplary graphical user interface of the computing device of FIG. 1 shown displaying pre-start proposition market odds details with user sentiment visual elements not submitted by market odds type. 1220 indicates an exemplary graphical user interface that displays the pre-start event details for the proposition market odds with user sentiment visual elements not submitted by market odds type. 1221 indicates the graphical user interface element that represents how the user will enter their proposition market odd user sentiment submission for the event.

FIG. 12C is an exemplary graphical user interface of the computing device of FIG. 1 shown displaying pre-start event details for multiple concurrent event selections, or parlays, market odds with user sentiment visual elements not submitted by market odds type. 1230 indicates exemplary graphical user interface that displays the pre-start event details for multiple concurrent event selections, or parlays, market odds with user sentiment visual elements not submitted by market odds type.

1231 indicates the graphical user interface element that represents how the user will enter their moneyline parlay market odd user sentiment submission for the event. 1232 indicates the graphical user interface element that represents how the user will enter their spreads parlay market odd user sentiment submission for the event. 1233 indicates the graphical user interface element that represents how the user will enter their total over parlay market odd user sentiment submission for the event. 1234 indicates the graphical user interface element that represents how the user will enter their total under parlay market odd user sentiment submission for the event.

FIG. 12D is an exemplary graphical user interface of the computing device of FIG. 1 shown displaying the user sentiment agreeable submission. 1240 indicates an exemplary graphical user interface that displays the user sentiment agreeable submission. 1241 indicates a yes visual display element or button. If the user submits this visual display element, they are submitting an agreeable sentiment for the published sports market odds. 1242 indicates a no visual display element or button that will take the user to view 1254 to continue with their disagreement sentiment. 1243 indicates a cancel visual display element or button that will cancel out the action. 1244 indicates an exemplary pre-event visual displaying a user submitting a yes or confirmation that they want to enter their sentiment.

FIG. 12E is an exemplary graphical user interface of the computing device of FIG. 1 shown displaying the user sentiment disagreeable submission. 1250 indicates an exemplary graphical user interface that displays the user sentiment agreeable submission. 1251 indicates a yes or confirmation visual display element or button. If user submits this visual display element, they are submitting an agreeable sentiment for the published sports market odds. 1252 indicates a no, corresponding to a user submitting a disagreeable sentiment for the published sports market odds and are taken to 1254. 1253 indicates a cancel visual display element or button that will cancel out the action.

1254 indicates an exemplary pre-event visual displaying a user submitting a no confirmation that the user disagrees with the sentiment along with a prompt whether they want to customize the market odds. 1255 indicates a no or similar visual display element or button that enables a user to enter a disagreeable sentiment. 1256 indicates when the no button 1255 is clicked, a yes or confirmation visual element or button will display. If the user submits this visual display element, they are submitting that they want to customize the published sports market odds. 1257 indicates a no visual display element or button that will still log the disagreeable sentiment but not to customize the sports market odds. 1258 indicates a cancel visual display element or button that will cancel out the action. 1260 indicates an exemplary pre-event visual displaying a user submitting a yes or confirmation that they want to customize the published market odds values.

1261 indicates the pre-start visual displaying the current event start date and time. 1262 indicates the pre-start visual displaying the participant of the current event. 1263 indicates the pre-start visual displaying the current event point market odds value. 1264 indicates an exemplary visual element displaying where the user will enter their new customized point market odds value. 1265 indicates a save or confirmation visual display element or button. If user submits this visual display element, they will be submitting their customed point market odds value. 1266 indicates a no or cancel visual display element or button that will cancel out the customize action. 1270 indicates an exemplary visual displaying the user clicking save to submit their customized event market odds value. It will be appreciated that while the views in FIGS. 12A-12E have been described as “pre-start” event details, the views may also be presented as post-start event details such as for comparison purposes (e.g., for comparing sentiment and/or AI predictions).

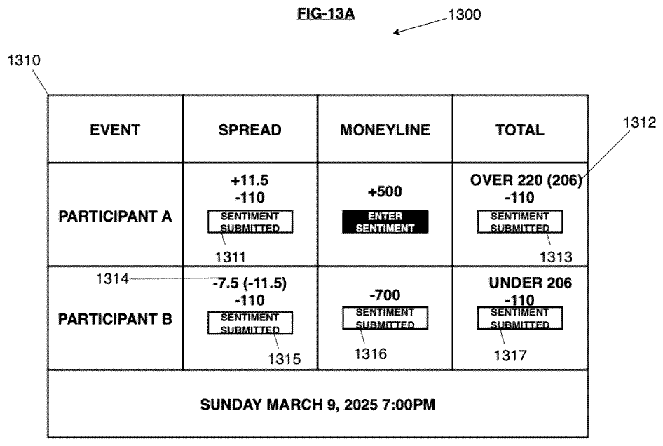

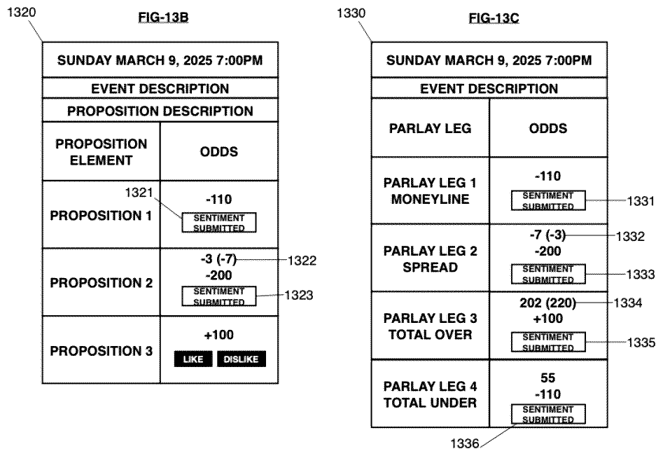

FIG. 13A is an exemplary graphical user interface of the computing device of FIG. 1 shown displaying post-start event market odds details with user sentiment visual elements submitted by market odds type. 1310 indicates an exemplary graphical user interface that displays the post-start event market odds details with customized user sentiment visual elements submitted for a given user. 1311 indicates the graphical user interface element displaying a user submitted sentiment confirmation for the spread point market odds for the first participant. There is no customization submitted. 1312 indicates the graphical user interface element displaying the user's customized total over point value for their disagreeable user sentiment submission. The original value is in parentheses. 1313 indicates the graphical user interface element displaying a user submitted sentiment confirmation for the total over point market odds. 1314 indicates the graphical user interface element displaying the user's customized spread point value for their disagreeable user sentiment submission for the second participant. The original value is in parentheses. 1315 indicates the second graphical user interface element displaying a user submitted sentiment confirmation for the spread point market odds for the second participant. 1316 indicates the graphical user interface element displaying a user submitted sentiment confirmation for the moneyline market odds for the second participant.

1317 indicates the graphical user interface element displaying the user's total under point disagreeable user sentiment submission. There is no customization submitted.

FIG. 13B is an exemplary graphical user interface of the computing device of FIG. 1 shown displaying post-start proposition market odds details with user sentiment visual elements submitted by market odds type. 1320 indicates exemplary graphical user interface that displays the post-start event details for the proposition market odds with user sentiment visual elements submitted for a given user. 1321 indicates the graphical user interface element displaying a user submitted sentiment confirmation for the given proposition market odds. 1322 indicates the user's customized market odds value from a disagreeable proposition sentiment submission. The original value in parentheses. 1323 indicates the graphical user interface element displaying a user submitted sentiment confirmation for the given proposition market odds.

FIG. 13C is an exemplary graphical user interface of the computing device of FIG. 1 shown displaying post-start event details for multiple concurrent event selections, or parlays, market odds with user sentiment visual elements submitted by market odds type. 1330 indicates an exemplary graphical user interface that displays the post-start event details for the parlay market odds with user sentiment visual elements submitted for a given user.

1331 indicates the visual element is updated when user submits their parlay sentiment for the published moneyline market odds value for the event. 1332 indicates the user's customized market odds value from a disagreeable spread point market odds parlay sentiment submission. The original value in parentheses. 1333 indicates the visual element is updated when user submits their parlay sentiment for the published spreads market odds value for the event. 1334 indicates the user's customized market odds value from a disagreeable total over point market odds parlay sentiment submission. The original value in parentheses. 1335 indicates the visual element is updated when user submits their parlay sentiment for the published total over market odds value for the event. 1336 indicates the visual element is updated when user submits their parlay sentiment for the published total under market odds value for the event. There is no customization submitted. While FIGS. 13A-13C have been described as displaying post-start event, FIGS. 13A-13C can also represent pre-start event data. In particular, FIGS. 13A-13C are displaying a user's submitted sentiment. This information can be graphically displayed during pre-start, when the user is still choosing what sentiment to submit, but it can also be displayed post-start, showing what the user submitted for a given event.

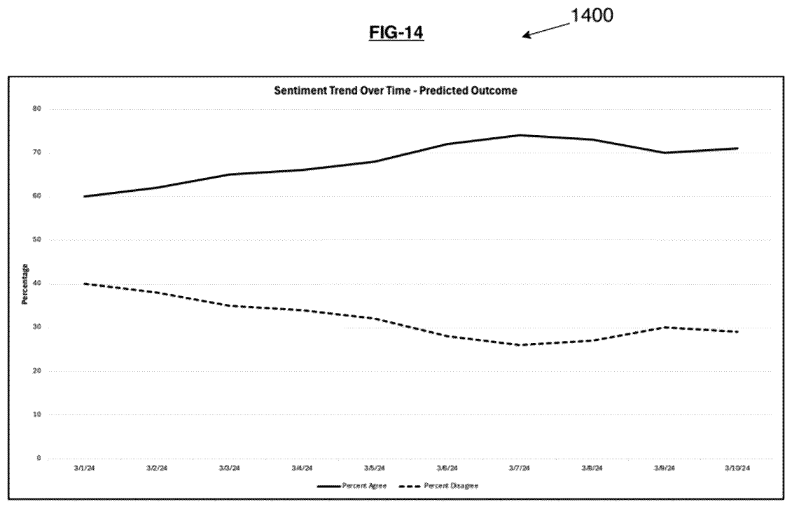

FIG. 14 is an exemplary graphical user interface of the computing device of FIG. 1 shown displaying an exemplary plot 1400 of sentiment trend over time according to various examples of the present disclosure.

In advanced embodiments, the system retrains its predictive models continuously or in real-time based on new data received. Parlay logic allows users to bundle multiple predictions into a single submission, with custom odds calculated based on interdependent probability logic or user-defined assumptions.

Detailed embodiments of the present disclosure are disclosed herein; however, it is to be understood that the disclosed embodiments are merely exemplary of the disclosure, which may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure.

The terms “a” or “an,” as used herein, are defined as one or more than one. The term “another,” as used herein, is defined as at least a second or more. The terms “including” and/or “having,” as used herein, are defined as comprising (i.e., open transition).

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entirety to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other types of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, Internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server. In embodiments, the server may be a virtual machine that is executed by a processing system of a cloud-services platform (e.g., Amazon AWS). In these embodiments, the cloud-services platform may offer computing resources that host and support various aspects of a third-party's software systems.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, Internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code, and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, and instructions described herein and elsewhere may be executed by one or more of the network infrastructural elements. The methods and systems described herein may be adapted for use with any kind of private, community, or hybrid cloud computing network or cloud computing environment, including those that involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or intangible items from one state to another. The methods and systems described herein may also transform data representing physical and/or intangible items from one state to another.

The elements described and depicted herein, including in flowcharts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flowchart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context. The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium. The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

The use of the terms “a” and “an” and “the” and similar referents in the context of describing the disclosure (especially in the context of the following claims) is to be construed to cover both the singular and the plural unless otherwise indicated herein or clearly contradicted by context. The terms “comprising,” “having,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one skilled in the art to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

Any element in a claim that does not explicitly state “means for” performing a specified function, or “step for” performing a specified function, is not to be interpreted as a “means” or “step” clause as specified in 35 U.S.C. § 112 (f). In particular, any use of “step of” in the claims is not intended to invoke the provision of 35 U.S.C. § 112 (f).

Persons skilled in the art may appreciate that numerous design configurations may be possible to enjoy the functional benefits of the inventive systems. Thus, given the wide variety of configurations and arrangements of embodiments of the present disclosure the scope of the present disclosure is reflected by the breadth of the claims below rather than narrowed by the embodiments described above.

What is claimed is:

1. A computer implemented method for predicting an outcome from an event based on user sentiment, the method comprising:
receiving, at a computing device having one or more processors, event market data, the event market data having a first predicted outcome from the event;
displaying, as rendered graphics on a visual display of the computing device, the first predicted outcome;
displaying, as rendered graphics on the visual display, available prompt selections indicative of a like and a dislike, wherein the like represents agreement with the first predicted outcome and the dislike represents disagreement with the first predicted outcome;
receiving, at the computing device, feedback associated with the first predicted outcome based on one of a selected like and dislike;
assigning and storing, at the computing device, a user sentiment score related to the user feedback; and
displaying, as rendered graphics on the visual display, the user sentiment score concurrently with the first predicted outcome from the event market data.

2. The method of claim 1, further comprising:
displaying, as rendered graphics on the visual display, and resulting from a selected dislike user feedback, available prompt selections indicative of customizing the first predicted outcome; and
displaying, as rendered graphics on the visual display, a field that receives a user new customized value that contradicts the first predicted outcome.

3. The method of claim 2, wherein assigning and storing, at the computing device, the user sentiment score related to the user feedback further comprises:
assigning the user new customized value as user defined odds to the user sentiment score and wherein the user sentiment score includes the user defined odds.

4. The method of claim 3, further comprising:
displaying, as rendered graphics on the visual display, a timeline or trend graph showing sentiment fluctuations over time for the first predicted outcome.

5. The method of claim 3, further comprising:
displaying, as rendered graphics on the visual display, and resulting from the user defined odds, an available prompt indicative of (i) a reason for the user new customized value; and (ii) a confidence score of the customized value indicative of a user's level of confidence related to the customized value.

6. The method of claim 3, further comprising:
receiving, at the computing device, feedback associated with the first predicted outcome from multiple users;
aggregating the feedback associated with the first predicted outcome from the multiple users; and
wherein the user sentiment score is displayed as rendered graphics on the visual display in real-time and is indicative of the aggregated feedback from the multiple users.

7. The method of claim 6, further comprising:
displaying, as rendered graphics on the visual display, at least one of an average, a minimum and a maximum customized value related to the feedback associated with the first predicted outcome from the multiple users.

8. The method of claim 3, further comprising:
collecting, at an artificial intelligence module of the computing device, (i) historical event results; and (ii) historical sentiment data;
collecting, at the AI module of the computing device, contemporary user sentiment data, and contemporary event data from the user sentiment score;
predicting a result of the event on a trained model executed at the AI module based on the historical event results and the contemporary user sentiment data and the contemporary event data; and
displaying, as rendered graphics on the visual display, AI predictions based on the predicated result.

9. The method of claim 3, further comprising:
determining, at the computing device, a result from the event upon conclusion of the event;
comparing the result to the user defined odds;
assigning a user ranking based on the comparing; and
displaying, as rendered graphics on a visual display, the user ranking.

10. The method of claim 9 wherein the user sentiment score and user new customized value is weighted based on the user ranking.

11. The method of claim 1, wherein the event comprises one of a sporting competition, political race, entertainment award, and financial forecast.

12. The method of claim 1, wherein the outcome comprises one of a winner of the event, a statistic related to the event, a combined multiple event outcome, and a proposition related to an in-event performance metric.

13. A computing system, comprising:
one or more processors; and
a non-transitory computer-readable storage medium having a plurality of instructions stored thereon, which, when executed by the one or more processors, cause the one or more processors to perform operations comprising:
receiving, at a computing device having one or more processors, event market data, the event market data having a first predicted outcome from the event;
displaying, as rendered graphics on a visual display of the computing device, the first predicted outcome;
displaying, as rendered graphics on the visual display, available prompt selections indicative of a like and a dislike, wherein the like represents agreement with the first predicted outcome and the dislike represents disagreement with the first predicted outcome;
receiving, at the computing device, feedback associated with the first predicted outcome based on one of a selected like and dislike;
assigning and storing, at the computing device, a user sentiment score related to the user feedback; and
displaying, as rendered graphics on the visual display, the user sentiment score concurrently with the first predicted outcome from the event market data.

14. The computer system of claim 13, wherein the operations further comprise:
displaying, as rendered graphics on the visual display, and resulting from a selected dislike user feedback, available prompt selections indicative of customizing the first predicted outcome; and
displaying, as rendered graphics on the visual display, a field that receives a user new customized value that contradicts the first predicted outcome.

15. The computer system of claim 14, wherein assigning and storing, at the computing device, the user sentiment score related to the user feedback further comprises:
assigning the user new customized value as user defined odds to the user sentiment score and wherein the user sentiment score includes the user defined odds.

16. The computer system of claim 15, wherein the operations further comprise:
displaying, as rendered graphics on the visual display, and resulting from the user defined odds, an available prompt indicative of (i) a reason for the user new customized value; and (ii) a confidence score of the customized value indicative of a user's level of confidence related to the customized value.

17. The computer system of claim 15, wherein the operations further comprise:
receiving, at the computing device, feedback associated with the first predicted outcome from multiple users;
aggregating the feedback associated with the first predicted outcome from the multiple users; and
wherein the user sentiment score is displayed as rendered graphics on the visual display in real-time and is indicative of the aggregated feedback from the multiple users.

18. The computer system of claim 17, wherein the operations further comprise:
displaying, as rendered graphics on the visual display, at least one of an average, a minimum and a maximum customized value related to the feedback associated with the first predicted outcome from the multiple users.

19. The computer system of claim 17, wherein the operations further comprise:
displaying, as rendered graphics on the visual display, a timeline or trend graph showing sentiment fluctuations over time for the first predicted outcome.

20. The computer system of claim 15, wherein the operations further comprise:
collecting, at an artificial intelligence module of the computing device, (i) historical event results; and (ii) historical sentiment data;
collecting, at the AI module of the computing device, contemporary user sentiment data, and contemporary event data from the user sentiment score;
predicting a result of the event on a trained model executed at the AI module based on the historical event results and the contemporary user sentiment data and the contemporary event data; and
displaying, as rendered graphics on the visual display, AI predictions based on the predicated result.

21. The computer system of claim 15, wherein the operations further comprise:
determining, at the computing device, a result from the event upon conclusion of the event;
comparing the result to the user defined odds;
assigning a user ranking based on the comparing; and
displaying, as rendered graphics on a visual display, the user ranking.

22. The computer system of claim 21 wherein the user sentiment score and user new customized value is weighted based on the user ranking.

23. The computer system of claim 13, wherein the event comprises one of a sporting competition, political race, entertainment award, and financial forecast.

24. The computer system of claim 13, wherein the outcome comprises one of a winner of the event, a statistic related to the event, a combined multiple event outcome and a proposition related to an in-event performance metric.
